(19) United States
(12) Patent Application Publication
(10) Pub. No.: US 2012/0050433 A1
(43) Pub. Date: Mar. 1, 2012

(54) IMAGE RECORDING APPARATUS

(75) Inventor: Tatsuo FUJIKURA, Kanagawa (JP)

(73) Assignee: FUJIFILM CORPORATION, Minato-ku (JP)

(21) Appl. No.: 13/196,883

(22) Filed: Aug. 2, 2011

(30) Foreign Application Priority Data
Aug. 25, 2010 (JP) 2010-188834

(51) Int. Cl. B41J 2/01

(52) U.S. Cl. 347/102

(57) ABSTRACT

A continuous form printing apparatus includes: a conveying unit that conveys a web (continuous paper); an image forming section for front surface printing that records an image on a front surface of the web; an ink drying section that delivers a warm air flow to and dries the web; a seasoning device that delivers outside air to, to thereby adjust the moisture of, the web; and an image forming section for back surface printing that records an image on a back surface of the web. The continuous form printing apparatus also includes: an ink drying section that delivers a warm air flow to and dries the web after back surface printing; and a seasoning device that delivers outside air to, to thereby adjust the moisture of, the web. According to the above configuration, the moisture content of a continuous recording medium such as continuous paper can be made uniform.

### CROSS-REFERENCE TO RELATED APPLICATION

This application claims priority under 35 USC 119 from Japanese Patent Application No. 2010-188834, filed on Aug. 25, 2010, the disclosure of which is incorporated by reference herein.

### BACKGROUND OF THE INVENTION

1. Field of the Invention

The present invention relates to an image recording apparatus that records an image on a continuous recording medium such as continuous paper.

2. Description of the Related Art

Conventionally, image recording apparatus that convey continuous paper that has been paid out from a feed roll and record character information, images, and so forth on the continuous paper have been known. The image recording apparatus, for example, jet water-based ink with an inkjet recording head to record character information and images on the continuous paper and dry and fix the ink that has been jetted onto a front surface of the continuous paper (e.g., see Japanese Patent Application Laid-Open (JP-A) No. 2009-226839).

In such image recording apparatus, there are cases where expansion/contraction changes in the continuous paper arise due to changes in the moisture content in the continuous paper. In such cases, when printing on the front and back of the continuous paper, there is the potential for front and back misregistration to occur and for interference with the inkjet recording head resulting from rising of the continuous paper at the time of back surface printing to occur. Further, when performing a post-treatment on the continuous paper after printing, there is the potential for treatment defects to occur because of expansion/contraction changes in the continuous paper.

In JP-A No. 3-189196, there is disclosed a form production method where an adhesive is applied to paper (continuous paper) that is conveyed, an air flow is blown onto the paper to dry the adhesive, and the surface of the paper to which the adhesive has been applied and other paper are compressed and adhered together.

However, the method in JP-A No. 3-189196 is for promoting the drying of the adhesive and speeding up the production of the form and is not for making uniform the moisture content in continuous paper.

### SUMMARY OF THE INVENTION

In consideration of the above circumstances, an object of the present invention is to provide an image recording apparatus that can make uniform the moisture content of a continuous recording medium such as continuous paper and can amend and ease shrinkage changes in the continuous recording medium resulting from changes in the moisture content.

An image recording apparatus of a first aspect of the invention includes: a conveying unit that conveys a continuous recording medium that has been unwound from a roll; a front surface liquid droplet jetting unit that jets liquid droplets onto a front surface of the continuous recording medium that is conveyed by the conveying unit; a drying unit that is disposed on a downstream side of the front surface liquid droplet jetting unit in a conveyance direction of the continuous recording medium and dries the front surface of the continuous recording medium; and a moisture adjusting unit that delivers outside air to, to thereby adjust the moisture of, the continuous recording medium after drying by the drying unit.

According to this aspect, the front surface liquid droplet jetting unit jets the liquid droplets onto the front surface of the continuous recording medium, the drying unit dries the front surface of the continuous recording medium, and thereafter the moisture adjusting unit makes uniform the moisture content of the continuous recording medium by delivering the outside air and adjusting the moisture content of the continuous recording medium. Because of this, shrinkage changes in the continuous recording medium resulting from changes in the moisture content can be amended and eased.

An image recording apparatus of a second aspect of the invention is the image forming apparatus of the first aspect and further includes a back surface liquid droplet jetting unit that is disposed on the downstream side of the moisture adjusting unit in the conveyance direction of the continuous recording medium and jets liquid droplets onto a back surface of the continuous recording medium.

According to this aspect, the moisture adjusting unit adjusts the moisture of the continuous recording medium, and thereafter the back surface liquid droplet jetting unit jets the liquid droplets onto the back surface of the continuous recording medium. The moisture adjusting unit adjusts the moisture content of the continuous recording medium, whereby shrinkage changes in the continuous recording medium are amended and eased, so when the back surface liquid droplet jetting unit records an image on the back surface of the continuous recording medium, the occurrence of misregistration of the front and back of the continuous recording medium and interference with the back surface liquid droplet jetting unit resulting from rising of the continuous recording medium can be suppressed.

An image recording apparatus of a third aspect of the invention is the image recording apparatus of the first or second aspects and further includes a first blocking member that blocks the flow of heat and air between the drying unit and the moisture adjusting unit.

According to this aspect, the first blocking member blocks the flow of heat and air between the drying unit and the moisture adjusting unit, whereby the moisture content of the continuous recording medium can more reliably be made uniform.

An image recording apparatus of a fourth aspect of the invention is the image recording apparatus of any of the first to third aspects and further includes a second blocking member that blocks the flow of heat and air between the moisture adjusting unit and the front surface liquid droplet jetting unit or the back surface liquid droplet jetting unit.

According to this aspect, the second blocking member blocks the flow of heat and air between the moisture adjusting unit and the front surface liquid droplet jetting unit or the back surface liquid droplet jetting unit, whereby the moisture content of the continuous recording medium can more reliably be made uniform.

An image recording apparatus of a fifth aspect of the invention is the image recording apparatus of any of the first to fourth aspects, wherein the moisture adjusting unit has: a plurality of rolls that are placed alternately vertically, across which the continuous recording medium is disposed, and which form intervals in the continuous recording medium; and a plurality of fans that are placed on one side in a width direction of the continuous recording medium, deliver outside air between the intervals of the continuous recording medium, and discharge the outside air from the other side in the width direction of the continuous recording medium.

According to this aspect, the continuous recording medium is disposed across the plural rolls that are placed alternatively vertically, the continuous recording medium is conveyed in a state in which the intervals are formed in the continuous recording medium, the outside air is delivered between the intervals of the continuous recording medium by the plural fans from the one side in the width direction of the continuous recording medium, and the outside air is discharged from the other side in the width direction of the continuous recording medium. Because of this, the continuous recording medium is acclimated through air flows, whereby the moisture content of the continuous recording medium can more effectively be made uniform.

An image recording apparatus of a sixth aspect of the invention is the image recording apparatus of the fourth aspect, wherein the second blocking member is a box body in which slits through which the continuous recording medium enters and exits are formed, and the outside air is delivered into the box body.

According to this aspect, the continuous recording medium enters and exits through the slits formed in the box body, and the outside air is delivered into the box body. The flow of heat and air is blocked between the moisture adjusting unit and the front surface liquid droplet jetting unit or the back surface liquid droplet jetting unit by the box body, and the moisture content of the continuous recording medium can more reliably be made uniform.

An image recording apparatus of a seventh aspect of the invention is the image recording apparatus of any of the second to sixth aspects and further includes: a back surface-use drying unit that is disposed on the downstream side of the back surface liquid droplet jetting unit in the conveyance direction of the continuous recording medium and dries the back surface of the continuous recording medium; and a back surface-use moisture adjusting unit that delivers outside air to, to thereby adjust the moisture of, the continuous recording medium after drying by the back surface-use drying unit.

According to this aspect, the back surface liquid droplet jetting unit jets the liquid droplets onto the back surface of the continuous recording medium, the back surface-use drying unit dries the back surface of the continuous recording medium, and thereafter the back surface-use moisture adjusting unit makes uniform the moisture content of the continuous recording medium by delivering the outside air and adjusting the moisture content of the continuous recording medium. Because of this, shrinkage changes in the continuous recording medium resulting from changes in the moisture content can be amended and eased.

An image recording apparatus of an eighth aspect of the invention is the image recording apparatus of any of the first to seventh aspects and further includes: a process liquid applying unit that applies a process liquid to the continuous recording medium before liquid droplet jetting; and a process liquid drying unit that dries the process liquid that has been applied to the continuous recording medium.

According to this aspect, even in the case of applying the process liquid to the continuous recording medium before liquid droplet jetting and drying the process liquid, the moisture adjusting unit delivers the outside air and adjusts the moisture of the continuous recording medium after liquid droplet jetting, whereby the moisture content of the continuous recording medium can be made uniform.

An image recording apparatus of a ninth aspect of the invention is the image recording apparatus of any of the first to eighth aspects and further includes a post-treatment device that is disposed on the downstream side of the moisture adjusting unit or the back surface-use moisture adjusting unit in the conveyance direction of the continuous recording medium and performs a post-treatment on the continuous recording medium after image recording.

According to this aspect, the moisture content of the continuous recording medium is made uniform by the moisture adjusting unit or the back surface-use moisture adjusting unit, and shrinkage changes in the continuous recording medium are amended and eased, so even in a case where a post-treatment device performs a post-treatment on the continuous recording paper, the occurrence of treatment defects can be suppressed.

An image recording apparatus of a tenth aspect of the invention is the image recording apparatus of any of the first to ninth aspects, wherein the drying unit or the back surface-use drying unit blows a warm air flow onto and dries the continuous recording medium.

According to this aspect, even when a warm air flow has been blown onto and dried the continuous recording medium, the moisture content of the continuous recording medium can be made uniform by adjusting the moisture of the continuous recording medium thereafter.

Because the present invention is given the above configurations, it can made uniform the moisture content of a continuous recording medium and can amend and ease shrinkage changes in the continuous recording medium resulting from changes in the moisture content.

### BRIEF DESCRIPTION OF THE DRAWINGS

FIG. 1 is a configuration diagram showing a continuous form printing apparatus pertaining to an embodiment of the present invention;

FIG. 2 is a side view showing a seasoning device that is used in the continuous form printing apparatus pertaining to the embodiment of the present invention;

FIG. 3 is a graph in which the relationship between time and the moisture content of continuous paper in each processing step of the continuous form printing apparatus is compared between when front surface seasoning has been performed and a case where front surface seasoning is not performed;

FIG. 4 is a diagram showing a state of occurrence of expansion/contraction and cockles in continuous paper; and

FIG. 5 is a configuration diagram showing the neighborhood of a seasoning device that is used in a continuous form printing apparatus pertaining to a modification of the embodiment.

### DETAILED DESCRIPTION OF THE INVENTION

An example of an embodiment pertaining to the present invention will be described below with reference to the drawings.

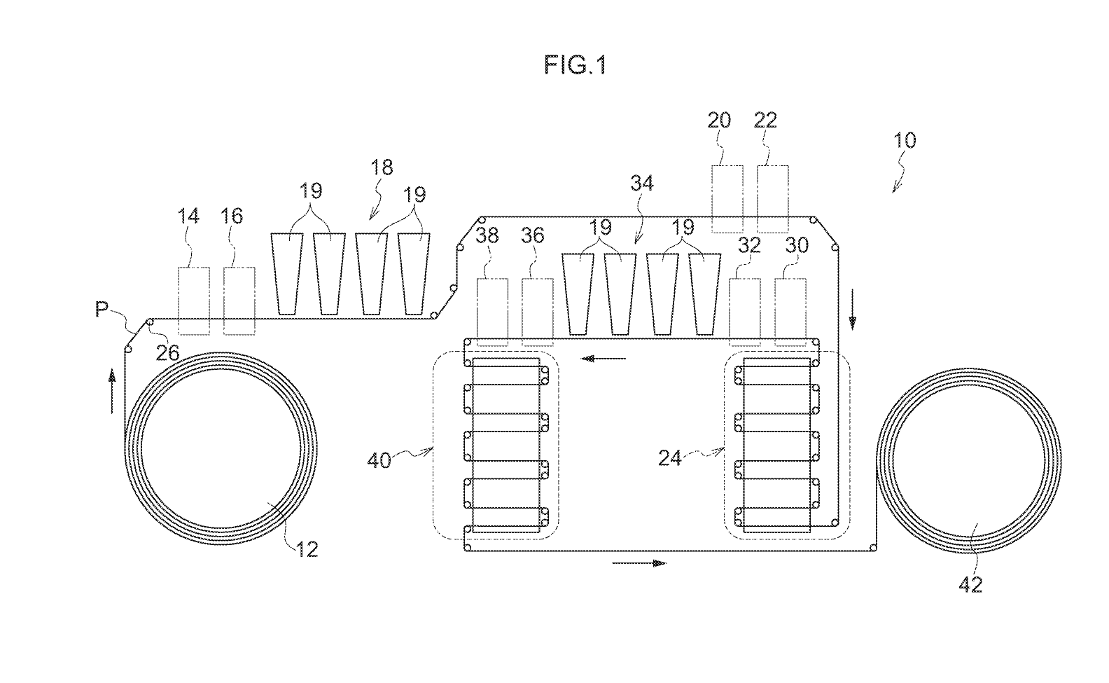

As shown in FIG. 1, a continuous form printing apparatus 10 serving as one example of an image recording apparatus pertaining to the present embodiment is a two-sided printing apparatus that conveys a web (continuous paper) P serving as a continuous recording medium and forms an image on a front surface and a back surface of the web P. In the continuous form printing apparatus 10, a feed roller 12 serving as a conveying unit that feeds and conveys the web P is disposed on an upstream side in a conveyance direction of the web P. The web P that has been pulled out from the feed roller 12 is conveyed in one direction in a state in which it is wrapped around plural rollers 26. Each of the processing sections in the continuous form printing apparatus 10 pertaining to the present embodiment is schematically shown in order to make it easier to understand the placement of each of the processing sections, and the components inside each of the processing sections are not shown.

On a conveyance direction downstream side of the feed roller 12, an unillustrated infeed section, a process liquid applying section 14 (a process liquid applying unit), a process liquid drying section 16 (a process liquid drying unit), an image forming section 18 (a front surface liquid droplet jetting unit), an ink drying section 20 (a drying unit), a fixing section 22, and a seasoning device 24 (a moisture adjusting unit) are sequentially disposed along the conveyance direction of the web P. The infeed section pulls out the web P from the feed roller 12 and temporarily stores the web P. The process liquid applying section 14 applies a process liquid to the front surface (one recording surface on the top side in FIG. 1) of the web P. The process liquid drying section 16 dries the process liquid that has been applied to the web P. The image forming section 18 jets ink droplets onto the front surface of the web P to form an image thereon. The ink drying section 20 dries with a warm air flow the ink (image) that has been jetted onto the web P. The fixing section 22 fixes the image to the web P. The seasoning device 24 delivers outside air to the web P to thereby stabilize the moisture content of the web P. The web P that has been wrapped around the plural rollers 26 passes through the seasoning device 24, whereby the back surface of the web P becomes the top side and the web P is conveyed.

Further, in the continuous form printing apparatus 10, a process liquid applying section 30 (a process liquid applying unit), a process liquid drying section 32 (a process liquid drying unit), an image forming section 34 (a back surface liquid droplet jetting unit), an ink drying section 36 (a back surface-use drying unit), a fixing section 38, and a seasoning device 40 (a back surface-use moisture adjusting unit) are sequentially disposed along the conveyance direction of the web P on the downstream side of the seasoning device 24 in the conveyance direction of the web P. The process liquid applying section 30 applies a process liquid to the back surface (another recording surface on the top side in FIG. 1) of the web P. The process liquid drying section 32 dries the process liquid that has been applied to the web P. The image forming section 34 jets ink droplets onto the back surface of the web P to form an image thereon. The ink drying section 36 dries with a warm air flow the ink (image) that has been jetted onto the web P. The fixing section 38 fixes the image to the web P. The seasoning device 40 delivers outside air to the web P to thereby stabilize the moisture content of the web P. Moreover, in the continuous form printing apparatus 10, an unillustrated outfeed section and a collecting roller 42 are disposed on the downstream side of the seasoning device 40 in the conveyance direction of the web P. The outfeed section temporarily stores the web P. The collecting roller 42 collects the web P to which an image has been fixed.

Further, although there are no particular restrictions on the continuous recording medium that is used as the web P, general printing paper whose main constituent is cellulose—such as so-called wood-free paper, coated paper, and art paper—and which is used in general offset printing and so forth can be used.

With general printing paper whose main constituent is cellulose, in image recording resulting from general inkjet methods using water-based ink, ink absorption and drying are comparatively slow, color material migration easily occurs after ejection, and image quality easily drops, but according to the inkjet recording of the present invention, the recording of a high-quality image that suppresses color material migration and which has excellent color density and color hue is possible. Each of the processing sections will be described below.

In the unillustrated infeed section that is placed on the conveyance direction downstream side of the feed roller 12, there is disposed an infeed pair that pulls out the web P from the feed roller 12. Further, adjustment of the tension in the web P is performed by dancer rollers (not shown in the drawings) that are swung and held up and down in order to temporarily store an adjustment margin of the web P needed for time to splice the web P and changing the conveyance speed of the web P.

In the process liquid applying section 14, there is placed an applying roller unit (not shown in the drawings) that applies to the front surface (the surface on which an image is recorded, the top side in the drawings) of the web P a process liquid that causes a flocculation reaction with the ink that is ejected in the later-described image forming section 18. The process liquid that is applied here includes a flocculant that causes the components in the ink composition to aggregate.

By applying this process liquid, the ink and the process liquid cause a flocculation reaction at the recording surface of the web P after image recording, problems and image failure such as bleeding, landing interference (unity), and color mixing after ink landing do not occur, and the formation of a high-quality image becomes possible.

The flocculant that is used may be a compound that can change the pH of the ink composition, or may be a multivalent metal salt, or may be a polyallylamine. Preferred examples of compounds that can lower the pH include highly water-soluble acidic substances (phosphoric acid, oxalic acid, malonic acid, citric acid, or derivatives of these compounds, or salts of these compounds, etc.). One type of acidic substance may be used alone, or two or more types of acidic substances may be combined. This raises cohesion and immobilizes the whole ink. It is preferred that the pH (25° C.) of the ink composition be equal to or greater than 8.0 and that the pH (25° C.) of the process liquid be in the range of 0.5 to 4. This makes it possible to raise image density, resolution, and to speed up inkjet recording.

Further, other additives (publicly known additives such as an anti-drying agent (=a wetting agent), an anti-fading agent, an emulsion stabilizer, a permeation enhancer, a UV absorber, a preservative, an antifungal agent, a pH modifier, a surface tension modifier, a defoamer, a viscosity modifier, a dispersant, a dispersion stabilizer, a corrosion inhibitor, a chelating agent, etc.) can also be included in the process liquid.

In the process liquid drying section 16, there are disposed dancer rollers (not shown in the drawings) that are swung and held in the vertical direction and perform adjustment of the tension in the web P in order to temporarily store the web P needed for time to splice the web P and changing the conveyance speed of the web P. The process liquid drying section 16 is given a configuration where a heated air flow is blown onto the web P from an unillustrated fan heater to thereby heat and dry the web P that is stretched across the dancer rollers (not shown in the drawings).

As shown in FIG. 1, in the image forming section 18, one or plural recording heads 19 are disposed in positions opposing the front surface (recording surface) of the web P. In the example shown in FIG. 1, four recording heads 19 jet ink droplets of the colors of C, M, Y, and K onto the front surface of the web P to form an image thereon. In that case, the image forming section 18 may be given a configuration where the conveyance path of the web P is given a convex shape in which the recording surface side bulges and tension is applied to the web P so that flapping of the web P is controlled and a clearance between each of the recording heads 19 and the recording surface is ensured.

The ink jetted from the recording heads 19 is a water-based ultraviolet-curable ink, for example, and includes a pigment, polymer particles, and a water-soluble polymerizable compound that is polymerized by an active energy ray. A water-based ultraviolet-curable ink is curable as a result of ultraviolet light being applied thereto and forms an image that has excellent ability to withstand scratches on the recording surface and whose film strength is high.

For the pigment, for example, a water-dispersible pigment in which at least part of the surface thereof is coated with a polymeric dispersant is used. It is preferred that the acid value of the polymeric dispersant be in the range of 25 to 100 mg KOH/g. Because of this, the stability of self-dispersion becomes good and cohesion when the process liquid makes contact becomes good. Further, for the polymer particles, self-dispersing polymer particles whose acid value is 20 to 50 mg KOH/g are preferably used. Because of this, the ink can be made into one in which the stability of self-dispersion is good and cohesion when the process liquid makes contact is good.

As the polymerizable compound, a nonionic or cationic polymerizable compound is preferred in terms of not impeding the reaction between the flocculant and the pigment and polymer particles, and a polymerizable compound whose solubility with respect to water is equal to or greater than 10% by mass (or equal to greater than 15% by mass) is preferred.

At least one of the ink composition and the process liquid may further include an initiator that initiates the polymerization of the polymerizable compound by the active energy ray. For the initiator, a compound that can initiate the polymerization reaction by the active energy ray can be appropriately selected and included; for example, an initiator (e.g., a photopolymerization initiator) that generates an active species (radical, acid, base, etc.) by radiation, light, or an electron beam can be used.

Further, the ink includes water at 50 to 70% by mass, and other water-soluble organic solvents and publicly known additives—such as an anti-drying agent (a wetting agent), an anti-fading agent, an emulsion stabilizer, a permeation enhancer, a UV absorber, a preservative, an antifungal agent, a pH modifier, a surface tension modifier, a defoamer, a viscosity modifier, a dispersant, a dispersion stabilizer, a corrosion inhibitor, a chelating agent, etc.—may also be added.

The ink drying section 20 is equipped with high-temperature drying rolls (not shown in the drawings) around which the surface on the opposite side of the front surface (recording surface) of the web P is wrapped. The ink drying section 20 is given a configuration where a heated air flow is blown onto the web P from an unillustrated fan heater to thereby heat and dry the front surface (recording surface) of the web P that is wrapped around the high-temperature drying rolls.

In the fixing section 22, there is disposed an ultraviolet emitting light source (not shown in the drawings). The ultraviolet emitting light source applies ultraviolet light to the front surface (recording surface) of the web P after image recording to thereby solidify the aggregate of the process liquid and the ink.

After this, the seasoning device 24 that is disposed on the downstream side in the conveyance direction of the web P delivers outside air to the web P, whereby the moisture content of the web P is stabilized. Here, “seasoning” means stabilizing the water content of a recording medium by acclimating the recording medium to a certain temperature and humidity, and so-called moisture adjustment is also included. The configuration of the seasoning device 24 will be described later.

After this, an image is formed on the back surface of the web P, but description thereof will be omitted because the process liquid applying section 30, the process liquid drying section 32, the image forming section 34, the ink drying section 36, the fixing section 38, and the seasoning device 40 that are placed on the downstream side in the conveyance direction of the web P have basically the same configurations as those of the process liquid applying section 14, the process liquid drying section 16, the image forming section 18, the ink drying section 20, and the seasoning device 24 (front surface-use moisture adjusting unit) that have been described above.

The continuous form printing apparatus 10 may also be configured such that, after the images on the front surface (one recording surface) and the back surface (the other recording surface) of the web P have been fixed, the images on the front surface (one recording surface) and the back surface (other recording surface) are read by an unillustrated scanner to detect jetting defects, landing position deviations, density deviations, and so forth resulting from problems in the recording heads 19 when the images were formed in the image forming sections 18 and 34 and such that information is fed back to an unillustrated controller for correction and adjustment.

In the unillustrated outfeed section that is placed on the downstream side of the seasoning device 40 in the conveyance direction of the web P, there is disposed an outfeed pair that pulls out the web P from the feed roller 12. Further, adjustment of the tension in the web P is performed by dancer rollers (not shown in the drawings) that are swung and held in the vertical direction in order to temporarily store an adjustment margin of the web P needed for time to splice the web P and changing the conveyance speed of the web P. Additionally, the web P that has been conveyed is taken up and collected on a collecting roller 42.

The continuous form printing apparatus 10 may also be given a configuration where a folder serving as a post-treatment device is disposed instead of the collecting roller 42 so that the web P is folded and collected rather than being collected in a roll form. Further, a post-treatment device such as a cutter may also be disposed instead of the collecting roller 42.

In the continuous form printing apparatus 10, as shown in FIG. 1, the web P is pulled out from the feed roller 12 placed on the left side in the drawing. When front surface printing is to be performed, the front surface of the web P is made the top side, the web P is conveyed from left to right and passes through the seasoning device 24, and then the back surface of the web P is made the top side. Moreover, when back surface printing is to be performed, the web P is conveyed from right to left, passes through the seasoning device 40, is conveyed from left to right, and is taken up by the collecting roller 42 placed on the right side in the drawing.

Next, the seasoning devices serving as an example of moisture adjusting units will be described. The seasoning device 24 (front surface-use moisture adjusting unit) and the seasoning device 40 (back surface-use moisture adjusting unit) have the same configuration, so here the seasoning device 24 will be described.

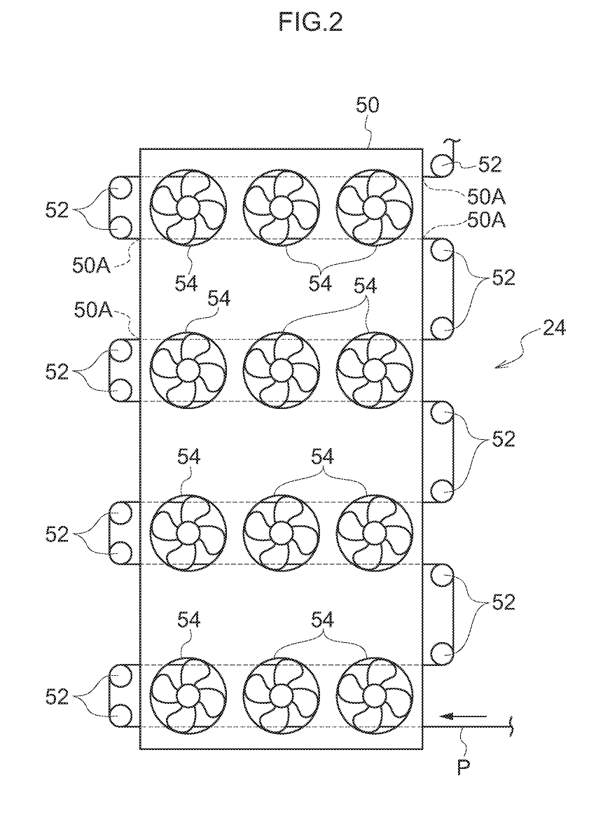

As shown in FIG. 2, in the seasoning device 24, plural rollers 52 are placed alternately at intervals vertically on both left and right sides (both sides along the conveyance direction of the web P) of a box-like housing 50 (box body) serving as a second shielding member. The web P is disposed across two of the rollers 52 at a time on both the left and right sides of the housing 50 and is conveyed in a state in which intervals are formed in the web P. Plural slits 50A for the web P to pass through are formed in both the left and right sides of the housing 50.

More specifically, the web P is conveyed in a substantially horizontal direction from the lower side inside the housing 50, is wrapped around two rollers 52 on the left side of the housing 50, is thereafter conveyed in a substantially horizontal direction inside the housing 50, is wrapped around two rollers 50 on the right side of the housing 50, is further conveyed in a substantially horizontal direction inside the housing 50, and is wrapped around two rollers 50 on the left side of the housing 50. This is repeated several times, whereby the web P is placed at intervals in the vertical direction inside the housing 50 and is conveyed from the lower side to the upper side between the plural rollers 52.

In a wall portion of the housing 50 on one side in a width direction of the web P, there are disposed plural fans 54 that deliver outside air to the web P that is conveyed. In the present embodiment, the fans 54 are placed between vertically paired sections of the web P, and three fans 54 are placed in the left-right direction of the housing 50. In a wall portion of the housing 50 on the other side in the width direction of the web P, there are disposed air exhaust portions (not shown in the drawings) through which the air flows that have been delivered into the housing 50 are exhausted. The plural fans 54 are configured to deliver the outside air from outside the continuous form printing apparatus 10, and the outside air that is delivered by the plural fans 54 is substantially the same temperature as the ambient temperature outside the continuous form printing apparatus 10.

In the seasoning device 24, the web P is acclimated through the outside air (air flows) that is delivered into the housing 50 while the web P is conveyed between the plural rollers 52, whereby the moisture in the web P is made uniform and expansion/contraction and deformation of the web P are amended and eased. In the present embodiment, the seasoning device 24 is configured to perform moisture adjustment of the web P in a short amount of time (e.g., about 10 seconds) by using the fans 54 whose air volume is large.

Further, the area surrounding the web P and the plural fans 54 that deliver the outside air to the web P is covered by the box-like housing 50, whereby the flow of heat and air between the image forming sections 18 and 34 and the seasoning devices 24 and 40 is blocked. Further, depending on the positions of the ink drying sections 20 and 36 and the fixing sections 22 and 38, the flow of heat and air between the ink drying sections 20 and 36 and fixing sections 22 and 38 and the seasoning devices 24 and 40 can also be blocked.

Next, the action and effects of the continuous form printing apparatus 10 will be described.

In the continuous form printing apparatus 10, in a front surface printing step an image is formed by the image forming section 18 on the front surface of the web P, the image is dried by the ink drying section 20, the image is fixed to the front surface of the web P by the fixing section 22, and thereafter the web P is conveyed to the seasoning device 24 for the front surface. The seasoning device 24 acclimates the web P by delivering the outside air to the web P while the web P is conveyed between the plural rollers 52, whereby the moisture content in the web P is made uniform and expansion/contraction and deformation of the web P are amended and eased. Thereafter, in a back surface printing step an image is formed by the image forming section 34 on the back surface of the web P, the image is dried by the ink drying section 36, the image is fixed to the back surface of the web P by the fixing section 38, and thereafter the web P is conveyed to the seasoning device 40 for the back surface. The seasoning device 40 acclimates the web P by delivering the outside air to the web P while the web P is conveyed between the plural rollers 52 (see FIG. 2), whereby the moisture content in the web P is made uniform and expansion/contraction and deformation of the web P are amended and eased.

In the continuous form printing apparatus 10, the image that has been formed on the front surface of the web P is dried and fixed, and thereafter the moisture content in the web P is made uniform and expansion/contraction and deformation of the web P are amended and eased by the seasoning device 24, whereby the occurrence of misregistration of the front and back of the web P when an image has been formed on the back surface of the web P and interference with the recording heads 19 resulting from rising (cockles, etc.) of the web P can be suppressed.

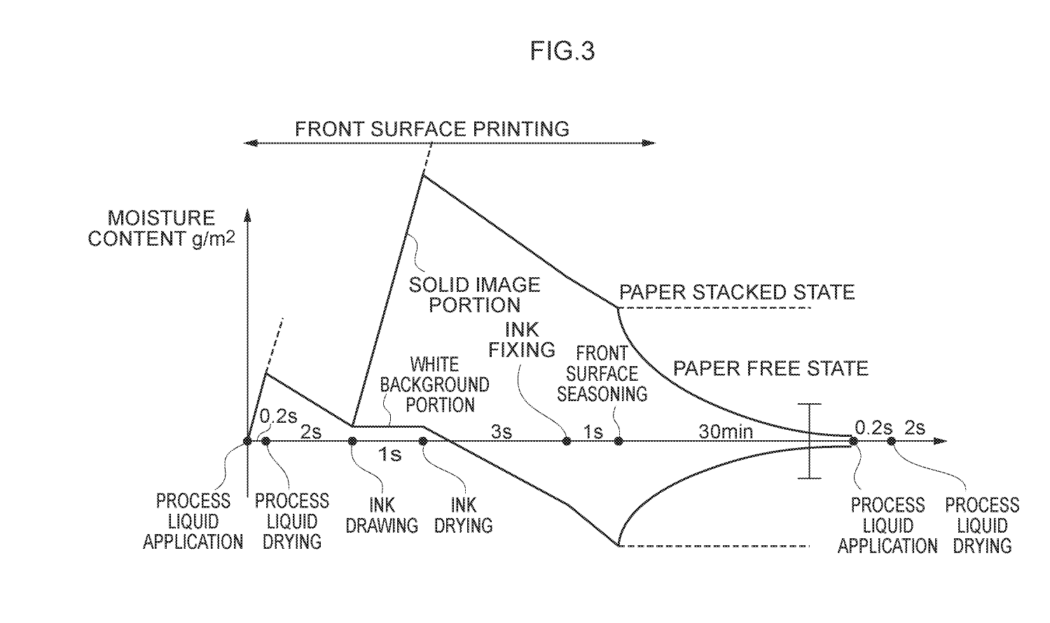

FIG. 3 is a graph showing the relationship between moisture content when the initial moisture content of the web P is 0 (g/m²) and time when the web P passes through each of the processing sections. As shown in FIG. 3, the moisture content of the web P rises with respect to the initial moisture content of the web P because of process liquid application, and the moisture content of the web P falls because of process liquid drying. Moreover, by forming (ink drawing) an image on the front surface of the web P, the moisture content of the solid image portion of the web P raises and the moisture content of the white background portion of the web P is maintained as is. Thereafter, when the web P undergoes ink drying and ink fixing, the moisture content of the solid image portion of the web P and the moisture content of the white background portion of the web P both fall, but the moisture content of the solid image portion of the web P after ink fixing is higher than the initial moisture content, and the moisture content of the white background portion of the web P is lower than the initial moisture content.

Next, by seasoning the front surface of the web P, the moisture content of the solid image portion of the web P and the moisture content of the white background portion of the web P are made uniform. Because of this, expansion/contraction and deformation of the web P are amended and eased. Next, process liquid application, process liquid drying, and so forth in the back surface printing step are performed.

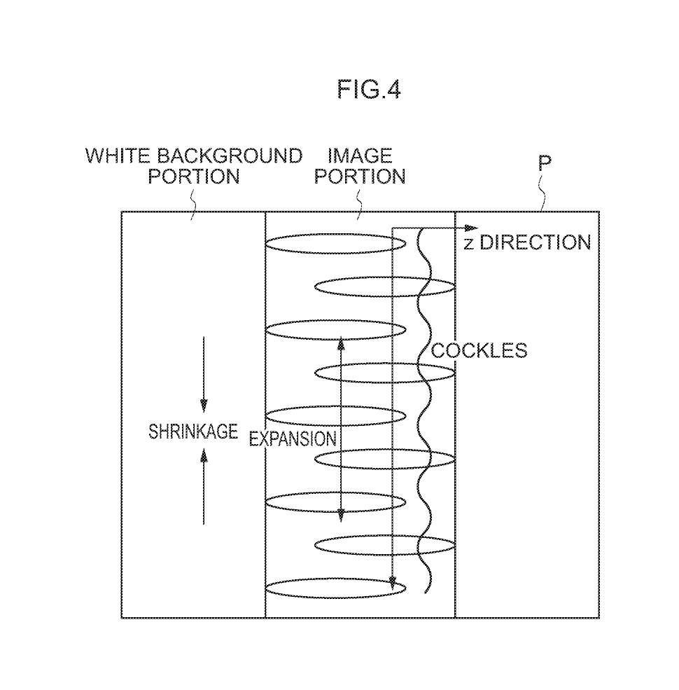

On the other hand, in a case where the front surface of the web P is not seasoned, as indicated by the dotted lines that represent a comparative example, there is a difference in the moisture content of the solid image portion of the web P and the moisture content of the white background portion of the web P. For this reason, as shown in FIG. 4, the white background portion of the web P shrinks, the solid image portion of the web P expands, and concavo-convex cockles easily form, and when an image is to be formed on the back surface of the web P there is the potential for misregistration of the front and back of the web P and for interference with the recording heads resulting from rising of the web P to occur. In contrast, in the continuous form printing apparatus 10 of the present embodiment, the moisture content of the solid image portion of the web P and the moisture content of the white background portion of the web P are made uniform and expansion/contraction and deformation of the web P are amended and eased, so the occurrence of misregistration of the front and back of the web P and interference with the recording heads resulting from rising of the web P can be suppressed.

Moreover, because the moisture content in the web P is made uniform by the seasoning device 40 after the image that has been formed on the back surface of the web P has been dried and fixed, expansion/contraction and deformation of the web P are amended and eased. Because of this, when, for example, the web P post-treated in a post-treatment device such as a folder or a cutter, the occurrence of treatment defects can be suppressed.

In the continuous form printing apparatus 10 of the present embodiment, as shown in FIG. 1, when front surface printing is performed, the front surface of the web P is made the top side, the web P is conveyed from left to right, and the web P passes through the seasoning device 24, and when back surface printing is performed, the back surface of the web P is made the top side and the web P is conveyed from right to left. However, the continuous form printing apparatus 10 is not limited to this configuration, and the positions of each of the processing sections and the conveyance direction of the web P may also be appropriately changed.

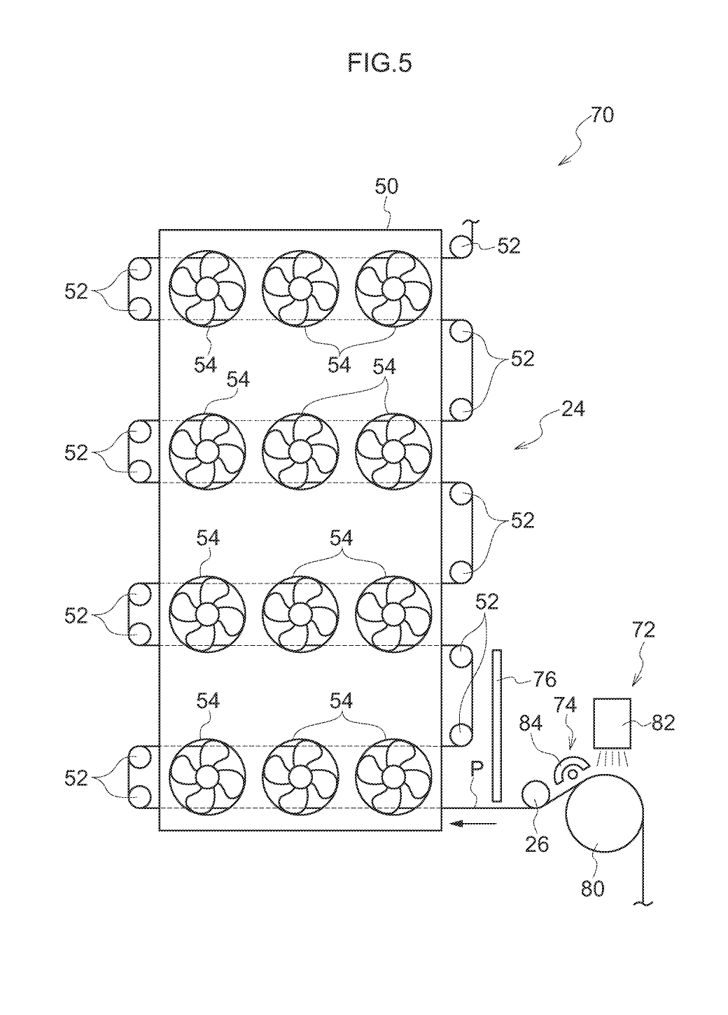

As shown in FIG. 5, in a continuous form printing apparatus 70 of a modification, the seasoning device 24 is disposed in the lateral direction of an ink drying section 72 and a fixing section 74 along the conveyance direction of the web P in the front surface printing step of the web P. The ink drying section 72 is equipped with a high-temperature drying roller 80 around which the web P is wrapped and a fan heater 82 that blows a heated air flow onto the front surface of the web P wrapped around the drying roller 80. The fixing section 74 is equipped with an ultraviolet emitting light source 84 that applies ultraviolet light to the front surface of the web P. Further, a shielding plate 76 serving as a first shielding member is disposed along the vertical direction between the seasoning device 24 and the ink drying section 72 and fixing section 74. The shielding plate 76 can block the flow of heat and air between the seasoning device 24 and the ink drying section 72 and fixing section 74. Because of this, the moisture content of the web P can more reliably be made uniform and expansion/contraction and deformation of the web P can be amended and eased by the seasoning device 24 after the image on the front surface of the web P has been appropriately dried and fixed by the ink drying section 72 and the fixing section 74 without being affected by the surrounding processing steps.

In the continuous form printing apparatus 10 of the present embodiment, the seasoning device 40 is disposed after back surface printing, but in cases and so forth where a post-treatment on the web P is not performed, for example, the seasoning device 40 may be omitted.

Further, depending on the positions of each of the processing sections, a shielding plate or the like may also be disposed between the front surface or back surface-use image forming section and the front surface or back surface-use seasoning device. Moreover, a shielding plate or the like may also be disposed between the front surface or back surface-use process liquid drying section and the front surface or back surface-use seasoning device.

Further, the drying sections are a type which blows a warm air flow onto and dries the web P, but the drying sections are not limited to this, and a different type of drying unit—such as a heater or a lamp—may also be used.

Further, the continuous form printing apparatus 10 of the present embodiment is a two-sided printing apparatus, but the present invention can also be applied to a case where an image is recorded only on one surface.

An embodiment of the present invention has been described above, but the present invention is in no way limited to the above embodiment and, it goes without saying, can be implemented in various aspects in a scope not departing from the gist of the present invention. The liquid jetted by the liquid droplet jetting units is not limited to ink for image printing and character printing and so forth and may also be applied to conductive pattern formation and so forth, such as a conductive liquid, for example.

What is claimed is:

1. An image recording apparatus comprising:
a conveying unit that conveys a continuous recording medium that has been unwound from a roll;
a front surface liquid droplet jetting unit that jets liquid droplets onto a front surface of the continuous recording medium that is conveyed by the conveying unit;
a drying unit that is disposed on a downstream side of the front surface liquid droplet jetting unit in a conveyance direction of the continuous recording medium and dries the front surface of the continuous recording medium; and
a moisture adjusting unit that delivers outside air to, to thereby adjust the moisture of, the continuous recording medium after drying by the drying unit.

2. The image recording apparatus according to claim 1, further comprising a back surface liquid droplet jetting unit that is disposed on the downstream side of the moisture adjusting unit in the conveyance direction of the continuous recording medium and jets liquid droplets onto a back surface of the continuous recording medium.

3. The image recording apparatus according to claim 1, further comprising a first blocking member that blocks the flow of heat and air between the drying unit and the moisture adjusting unit.

4. The image recording apparatus according to claim 1, further comprising a second blocking member that blocks the flow of heat and air between the moisture adjusting unit and the front surface liquid droplet jetting unit or the back surface liquid droplet jetting unit.

5. The image recording apparatus according to claim 1, wherein the moisture adjusting unit comprises a plurality of rolls that are placed alternately vertically, across which the continuous recording medium is disposed, and which form intervals in the continuous recording medium, and a plurality of fans that are placed on one side in a width direction of the continuous recording medium, deliver outside air between the intervals of the continuous recording medium, and discharge the outside air from the other side in the width direction of the continuous recording medium.

6. The image recording apparatus according to claim 4, wherein the second blocking member is a box body in which slits through which the continuous recording medium enters and exits are formed, and the outside air is delivered into the box body.

7. The image recording apparatus according to claim 2, further comprising a back surface-use drying unit that is disposed on the downstream side of the back surface liquid droplet jetting unit in the conveyance direction of the continuous recording medium and dries the back surface of the continuous recording medium, and a back surface-use moisture adjusting unit that delivers outside air to, to thereby adjust the moisture of, the continuous recording medium after drying by the back surface-use drying unit.

8. The image recording apparatus according to claim 1, further comprising a process liquid applying unit that applies a process liquid to the continuous recording medium before liquid droplet jetting, and a process liquid drying unit that dries the process liquid that has been applied to the continuous recording medium.

9. The image recording apparatus according to claim 1, further comprising a post-treatment device that is disposed on the downstream side of the moisture adjusting unit or the back surface-use moisture adjusting unit in the conveyance direction of the continuous recording medium and performs a post-treatment on the continuous recording medium after image recording.

10. The image recording apparatus according to claim 1, wherein the drying unit or the back surface-use drying unit blows a warm air flow onto and dries the continuous recording medium.
